(19) United States
(12) Patent Application Publication
(10) Pub. No.: US 2015/0082014 A1
(43) Pub. Date: Mar. 19, 2015

(54) Virtual Storage Devices Formed by Selected Partitions of a Physical Storage Device

(71) Applicant: International Business Machines Corporation, Armonk, NY (US)

(72) Inventors: Yoshiaki Funaki, Taipei (TW); Giant HM. Tu, Taipei (TW)

(21) Appl. No.: 14/447,111

(22) Filed: Jul. 30, 2014

(30) Foreign Application Priority Data
Jul. 31, 2013 (TW) 102127547

(51) Int. Cl. G06F 9/44; G06F 12/02; G06F 9/50

(52) U.S. Cl. CPC G06F 9/4408; G06F 9/5077; G06F 12/0246
USPC 713/2; 711/173; 711/103

(57) ABSTRACT

Disclosed is a computer system with a physical storage device. The physical storage device has a plurality of partitions and allows a user to select and combine at least two partitions to form a virtual storage device to be accessed by the operating system and makes unselected partitions inaccessible to the operating system.

### BACKGROUND

This application is based on and claims the benefit of priority from Taiwan Patent Application 102127547, filed on Jul. 31, 2013.

The present invention generally relates to managing partitions in a storage device, and more particularly, to selection of partitions in a storage device and access to the selected partitions.

The capacity of conventional storage devices, such as a hard disk drive or a solid-state drive (SSD), is becoming larger. To meet the need for the use and data management of a conventional storage device, the memory space of the conventional storage device is divided into multiple logical storage units commonly referred to as partitions. Each partition stores different data and allows the use of different file systems on the partition. The partitions allow a physical storage device to operate in a manner as if it were multiple storage devices operating simultaneously.

Partition data are usually stored in a master boot record (MBR). In general, the MBR is located at the first sector of the storage device. Whenever the computer boots, a basic input/output system (BIOS) reads a partition table of the MBR at the first sector to know how the partitions of the storage device are functioning, identify the booting partition, and thus load the operating system required for the booting process.

For more information about disk partitioning, visit the article under the heading “Disk Partition” published on the Wikipedia webpage.

### SUMMARY

In accordance with an illustrative embodiment, a method is provided for forming a virtual storage device. The method comprises selecting at least two partitions from a plurality of partitions of a physical storage device. The method further comprises combining the at least two partitions selected to form a virtual storage device. The method further comprises accessing the virtual storage device by the operating system and preventing unselected partitions from being accessed by the operating system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a computer system according to an illustrative embodiment; and

FIG. 2 is a block diagram illustrating creating a virtual partition table in firmware of a storage device in accordance with an illustrative embodiment;

FIG. 3 is a block diagram illustrating creating a virtual partition table in BIOS in accordance with an illustrative embodiment; and

FIG. 4 is a block diagram illustrating creating a a virtual partition table in a device driver of a storage device in accordance with an illustrative embodiment.

### DETAILED DESCRIPTION OF THE EMBODIMENTS

In one aspect, the illustrative embodiment provides a way of managing partitions in a physical storage device. According to the illustrative embodiment, a user can select any partitions from all the partitions available in the physical storage device and then combine or sort the selected partitions to create a virtual storage device. The capacity of the virtual storage device equals the sum of the respective capacities of the selected partitions, and thus the capacity of the virtual storage device might be less than the total capacity of the physical storage device.

In another aspect, the illustrative embodiment is based on the replacement of the physical storage device with a virtual storage device. Therefore, it is the virtual storage device composed of the selected partitions, rather than the physical storage device, that is “visible to” the operating system. As a result, the operating system can access the virtual storage device only. By contrast, unselected partitions are inaccessible to the operating system, because they are excluded from the virtual storage device and treated as if they were not connected to the host computer.

In another embodiment, even when only the same physical storage device is in use, the user can select different partitions or sort multiple identical partitions in different ways to form different virtual storage devices to be accessed by the operating system in the manner as if a variety of physical storage devices were provided to the operating system. Hence, the illustrative embodiment manifests a unique feature—dispensing with the hassle of changing a physical storage device by hand. The unique feature is advantageous when the embodiment is applied to a software testing environment, especially for the reason that the embodiment tests whether the sorting or quantity of partitions in the storage device affects software operation.

Unlike the illustrative embodiment, the prior art fails to enable a user to manage or select partitions of a storage device after the storage device has been divided into partitions. As a result, benefits of the partitions created in the storage device according to the prior art are limited, while conventional disk partitioning is mostly provided for storage space separation and multi-booting with separate partitions. U.S. Published Patent Application US2007/0283114 further discloses a simple switch whereby the host computer can only access a partition in a physical storage device in each instance: as a result, the benefits of US2007/0283114 are limited. By contrast, the illustrative embodiment discloses that multiple partitions in a physical storage device are freely combined to form different virtual storage devices.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

As will be appreciated by one skilled in the art, the present invention may be embodied as a system/device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

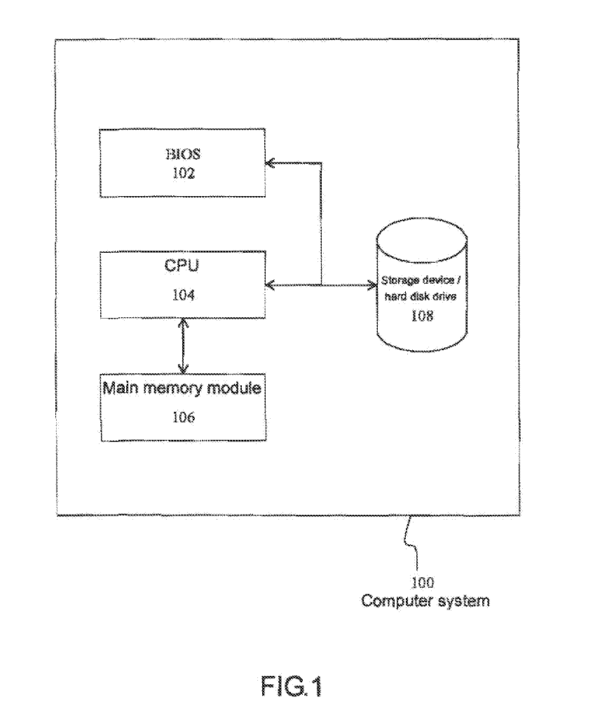

Referring now to FIG. 1 through FIG. 4, systems/devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

<System Framework>

FIG. 1 illustrates the hardware structure of a computer system 100 according to an illustrative embodiment. The computer system 100 comprises a basic input/output system (BIOS) 102, a central processing unit (CPU) 104, a main memory module 106, a storage device 108 (such as a hard disk drive, a solid-state drive (SSD), or another type of mass storage device). The CPU 104 executes an operating system (such as the WINDOWS® operating system or the Linux™ operating system). For further details of the other basic structures and components of the computer system 100, refer to conventional personal computers and servers, such as IBM's System X®, Blade Center®, and eServer™. Details not related to the present invention are omitted from the description below for the sake of brevity.

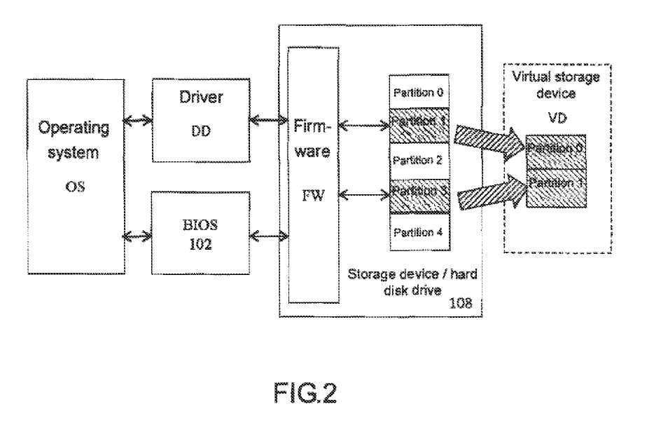

In embodiments described herein, the storage device 108 is provided in the form of a hard disk drive, but persons skilled in the art understand that the illustrative embodiment is not limited thereto. Referring to FIG. 2, in general, an operating system OS has a device driver DD of the storage device 108 in order to access data and files in the storage device 108. Moreover, the BIOS 102 communicates with the storage device 108 to gather hardware information of the storage device 108, for example. In this embodiment, a data access interface provided by a hard disk drive 108 to the device driver DD and the BIOS 102 includes, but is not limited to, Advanced Technology Attachment (ATA) and Serial Attached SCSI (SAS), but persons skilled in the art understand that any other appropriate hard disk drive data interfaces, such as SATA and SCSI, are also applicable to the illustrative embodiment. For further details of the basic structures of the hard disk drive 108, refer to IBM's hard disk drive products, such as IBM Enterprise SAS Hard Drives. The differences between the hard disk drive 108 and its conventional counterparts disclosed in the prior art are described below.

Like a conventional hard disk drive, the hard disk drive 108 has a partition table at the first sector of the zeroth head on the zeroth cylinder. As its name suggests, the first sector is a sector that comes first and is known as the master boot record (MBR). The partition table stores the address of each of the partitions in the hard disk drive 108 in accordance with a parameter, such as cylinder-head-sector (CHS), or by means of logical block addressing (LBA). The embodiment illustrated with Table 1 is exemplified by LBA to describe the partition table in the hard disk drive 108, but persons skilled in the art understand that LBA is illustrative rather than restrictive of the illustrative embodiment.

TABLE 1

| Original partition table | Initial LBA | Quantity of sectors |
|---|---|---|
| Partition 0 | 34 | 66 |
| Partition 1 | 100 | 100 |
| Partition 2 | 200 | 100 |
| Partition 3 | 300 | 200 |
| Partition 4 | 500 | 10000 |

<Creating Virtual Partition Table>

As soon as the computer system 100 boots, the BIOS 102 reads the MBR in the hard disk drive 108 to access the “original” partition table shown in Table 1. In particular, in this embodiment, before loading the operating system OS, the BIOS 102 provides a menu interface whereby a user selects from the “original” partition table the partitions to be combined to form a virtual storage device VD. Moreover, a partition in which an operating system to be booted is stored and selected by the user from the partitions required for forming the virtual storage device VD.

Referring to Table 1 and FIG. 2, the hard disk drive 108 has a total of five partitions (partition 0 through partition 4). In this exemplary embodiment, the user selects partition 1 and partition 3 for forming the virtual storage device VD, treats original partition 1 in the hard disk drive 108 as partition 0 (i.e., the first partition) in the virtual storage device VD, and treats original partition 3 in the hard disk drive 108 as partition 1 (i.e., the second partition) in the virtual storage device VD, such that the other original partitions (partition 0, partition 2, partition 4) in the hard disk drive 108 are temporarily excluded from the virtual storage device VD and thus are inaccessible to the operating system OS. Hence, the partition table of the virtual storage device VD is created, referred to as the virtual partition table hereinafter, and shown in Table 2

TABLE 2

| Virtual | Initial | Quantity of | |
|---|---|---|---|
| partition table | LBA | sectors | Remark |
| Partition 0 | 34 | 100 | Original partition 1 |
| Partition 1 | 134 | 200 | Original partition 3 |

Different operating systems (or different versions) are stored in partition 0 and partition 1 in the virtual storage device VD, respectively. For example, a Windows® operating system (traditional Chinese version) is stored in partition 0, whereas a Windows® operating system (Japanese version) is stored in partition 1. If the user uses a menu interface of the BIOS 102 to select partition 1 in the virtual storage device VD to be the booting partition, the BIOS 102 will load the Windows® operating system (Japanese version) from partition 1 to become the booting operating system.

In some situations, the drive letter assigned by the operating system OS to the virtual storage device VD depends on the sequence of the partitions in the virtual partition table. For instance, under a Windows® operating system, barring an additional change, the drive letter C: will be assigned to partition 0 (the first partition) in the virtual storage device VD, whereas the drive letter D: will be assigned to partition 1 (the second partition) in the virtual storage device VD. The result of software testing is likely to be affected by the drive letter assigned to the partition in which the software is stored.

In another embodiment (not shown), the user selects original partition 1 and original partition 3 for forming the virtual storage device VD, treats original partition 3 as partition 0 (i.e., the first partition) in the virtual storage device VD, and treats original partition 1 as partition 1 (i.e., the second partition) in the virtual storage device VD. Hence, the virtual partition table is created and shown in Table 3.

TABLE 3

| Virtual | Initial | Quantity of | |
|---|---|---|---|
| partition table | LBA | sectors | Remark |
| Partition 0 | 34 | 200 | Original partition 3 |
| Partition 1 | 234 | 100 | Original partition 1 |

The embodiments below further illustrate how the operating system OS accesses the virtual storage device VD.

### First Embodiment

Referring to FIG. 2, in this embodiment, the BIOS 102 is designed anew or modified so as to create a virtual partition table (i.e., one of the virtual partition tables shown in Table 2 and Table 3) in the hard disk drive 108 by the ATA interface according to the user's selection and store the virtual partition table in a firmware FW of the hard disk drive 108 or a specific reserved sector. Afterward, the BIOS 102 reads the virtual partition table (not the original partition table shown in Table 1) for performing a booting process and providing related data to the operating system OS. Hence, after the operating system OS loaded has finished performing the booting process, it is the virtual storage device VD with two partitions, rather than the hard disk drive 108 with five partitions, that is “visible to” the operating system OS.

Under the operating system OS, the partitions in the virtual storage device VD can be accessed by the driver DD through, for example, the ATA data interface, using a standard instruction set that complies with ATA rules. As only the virtual storage device VD is “visible to” the operating system OS, the device driver DD issues access instructions (including read/write instructions) in accordance with LBA and partition data in the virtual partition tables shown in Table 2 and Table 3. Afterward, upon receipt of the access instructions issued in accordance with the virtual partition tables of Table 2 and Table 3, the firmware FW of the hard disk drive 108 has to assess how LBA and partition data in the virtual partition tables relate to LBA and original partition data in the hard disk drive 108, so as to interpret the correct LBA from the “virtual LBA” indicated by the access instructions of the driver DD.

For instance, LBA: 134 (partition 1) in the virtual partition table shown in Table 2 is identified as relating to LBA: 300 (original partition 3) in the hard disk drive 108 shown in Table 1. It is only when the relationship is identified that the device driver DD can correctly access the required data or files in the hard disk drive 108.

### Second Embodiment

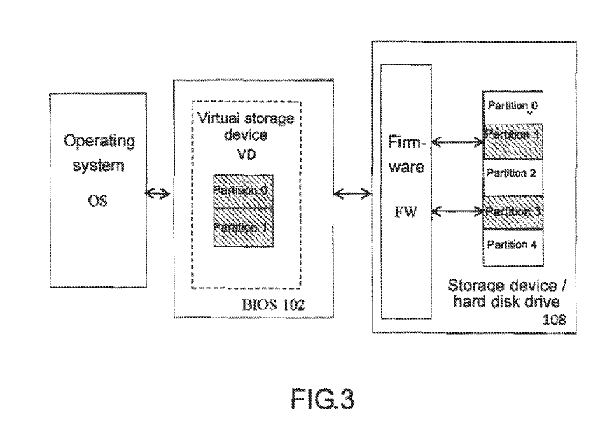

Referring to FIG. 3, in the second embodiment, the operating system OS cannot directly access the storage device and thus has to rely upon “int 13h” interruption in the BIOS 102 for issuing an instruction to inform the storage device of an address to be accessed. The virtual partition tables shown in Table 2 and Table 3 and illustrated with the second embodiment are stored in the BIOS 102 instead of a firmware or sector of the hard disk drive 108 illustrated with the first embodiment. The BIOS 102 is designed anew or modified so that, as soon as the computer system 100 boots, the virtual partition table (as opposed to the original partition table of Table 1) is provided to the operating system; hence, similarly, after the operating system has finished booting, it is only the virtual storage device VD, rather than the hard disk drive 108, that is “visible to” the operating system.

In this embodiment, it is practicable that the hard disk drive 108 is provided in the form of a conventional hard disk drive disclosed in the prior art and thus need not be adjusted or modified. As the BIOS 102 can access the virtual partition table and the original partition table of Table 1 simultaneously, the BIOS 102 can identify the relationship between LBA and partition data in the virtual partition table and LBA and original partition data in the hard disk drive 108. Hence, when the operating system OS accesses the partitions in the virtual storage device VD by the BIOS 102, the BIOS 102 changes “virtual LBA” indicated in the access instruction to the correct LBA and sends the changed access instruction to the hard disk drive 108, so as to access the required data or files in the hard disk drive 108 correctly.

### Third Embodiment

Referring to FIG. 4, the driver DD stored in the hard disk drive 108 and adapted for use in the operating system OS in the third embodiment substitutes for the BIOS 102 in the second embodiment to provide a virtual partition table and change “virtual LBA” indicated in the access instruction to the correct LBA. Hence, in this embodiment, the BIOS 102 can be a conventional BIOS disclosed in the prior art and thus need not be adjusted. In the third embodiment, during the initial stage of the booting process performed after the operating system OS has been loaded, the device driver DD provides a menu interface whereby the user selects from the “original” partition table in the hard disk drive 108 the partitions required for forming the virtual storage device VD. The device driver DD creates the virtual partition tables of Table 2 and Table 3 according to the constituent elements of the virtual storage device VD anticipated by the user and stores the virtual partition tables in the main memory module 106 (such as a DIMM module) shown in FIG. 1. After the operating system OS has finished performing a boot, the operating system OS responds to the virtual partition table created by the device driver DD by presenting to the user only the virtual storage device VD rather than the hard disk drive 108. When the operating system OS accesses the partitions in the virtual storage device VD through the device driver DD, the device driver DD makes reference to the relationship between LBA and partition data in the virtual partition table and LBA and original partition data in the hard disk drive 108 to therefore change “virtual LBA” indicated in the access instruction to the correct LBA and send the changed access instruction to the hard disk drive 108, so as to access the required data or files in the hard disk drive 108 correctly.

Unlike the first embodiment and the second embodiment, the third embodiment entails designing the device driver DD in a manner to automatically select, according to a rule preset by the user rather than by hand, from the “original” partition table of the hard disk drive 108 the partitions required for forming the virtual storage device VD in each instance of loading the operating system OS to perform a booting process. Hence, the aforesaid solution disclosed in the third embodiment is advantageous in a software automatic testing environment.

The foregoing embodiments are provided to illustrate and disclose the technical features of the illustrative embodiments, and are not intended to be restrictive of the scope of the present invention. Hence, all equivalent variations or modifications made to the foregoing embodiments without departing from the spirit embodied in the disclosure of the embodiments should fall within the scope of the present invention as set forth in the appended claims.

1: A computer system, comprising:
a central processing unit for executing an operating system; and
a physical storage device including a plurality of partitions from which a user selects at least two partitions, wherein the at least two partitions thus selected form a virtual storage device to be accessed by the operating system, and unselected partitions are inaccessible to the operating system.

2: The computer system of claim 1, wherein the physical storage device is a hard disk drive.

3: The computer system of claim 1, wherein the physical storage device is a solid-state drive.

4: The computer system of claim 1, wherein the physical storage device has a virtual partition table indicative of the at least two partitions selected stored in firmware of the physical storage device.

5: The computer system of claim 1, wherein a device driver of the physical storage device has a virtual partition table indicative of the at least two partitions selected.

6: The computer system of claim 1, further comprising a basic input/output system (BIOS) having a virtual partition table indicative of the at least two partitions selected.

7: A method for forming a virtual storage device in a computing system, the method comprising:
selecting at least two partitions from a plurality of partitions of physical storage device in the computing system;
combining the at least two partitions selected to form a virtual storage device;
accessing the virtual storage device by an operating system executing in the computing system; and
preventing unselected partitions of the physical storage device from being accessed by the operating system.

8: The method of claim 7, wherein the physical storage device is a hard disk drive.

9: The method of claim 7, wherein the physical storage device is a solid-state drive.

10: The method of claim 7, wherein the physical storage device has a virtual partition table indicative of the at least two partitions selected stored in firmware of the physical storage device.

11: The method of claim 10, wherein responsive to receiving an access instruction, the firmware uses the virtual partition table to translate logical block address and partition data in the access instruction to logical block address and partition data of the physical storage device.

12: The method of claim 7, wherein a device driver of the physical storage device has a virtual partition table indicative of the at least two partitions selected.

13: The method of claim 12, wherein the device driver provides a menu interface and the user selects the at least two partitions using the menu interface.

14: The method of claim 12, wherein responsive to the operating system accessing a partition in the virtual storage device, the device driver uses the virtual partition table to translate logical block address and partition data in the access instruction to logical block address and partition data of the physical storage device.

15: The method of claim 7, further comprising a basic input/output system (BIOS) having a virtual partition table indicative of the at least two partitions selected.

16: The method of claim 15, wherein responsive to booting the computing system, the basic input/output system provides the virtual partition table to the operating system.

17: The method of claim 15, wherein responsive to the operating system accessing a partition of the virtual storage device, the basic input/output system uses the virtual partition table to translate logical block address and partition data in the access instruction to logical block address and partition data of the physical storage device.

18: A computer program product comprising a computer readable storage medium having a computer readable program stored therein, wherein the computer readable program, when executed on a computing device, causes the computing device to:
select at least two partitions from a plurality of partitions of a physical storage device in a computing system;
combine the at least two partitions selected to form a virtual storage device;
access the virtual storage device by an operating system executing in the computing system; and
prevent unselected partitions from being accessed by the operating system.

19: The computer program product of claim 18, wherein a device driver of the physical storage device has a virtual partition table indicative of the at least two partitions selected.

20: The computer program product of claim 19, wherein the device driver provides a menu interface and the user selects the at least two partitions using the menu interface.
